(19) United States
(12) Patent Application Publication
(10) Pub. No.: US 2012/0043691 A1
(43) Pub. Date: Feb. 23, 2012

(54) MULTILAYERED POLYIMIDE FILM

(75) Inventor: Takeshi Uekido, Yamaguchi (JP)

(73) Assignee: UBE INDUSTRIES, LTD, Ube-shi (JP)

(21) Appl. No.: 13/266,386

(22) PCT Filed: Apr. 27, 2010
(86) PCT No.: PCT/JP10/57469

§ 371 Date: Oct. 26, 2011

(30) Foreign Application Priority Data
Apr. 28, 2009 (JP) 2009-108773

(51) Int. Cl. B29C 47/06; B32B 7/02; B29C 39/20; B32B 27/06

(52) U.S. Cl. 264/173.16; 428/473.5; 428/213; 264/165

(57) ABSTRACT

A multilayered polyimide film including a polyimide layer (b), and a pigment-containing polyimide layer (a) stacked on one surface or both surfaces of the polyimide layer (b), wherein the polyimide layer (b) is formed of a polyimide including an aromatic tetracarboxylic acid unit containing a 3,3′,4,4′-biphenyltetracarboxylic acid unit in an amount of 70 to 100 mol %, and an aromatic diamine unit containing a p-phenylenediamine unit in an amount of 70 to 100 mol %.

### TECHNICAL FIELD

The present invention relates to a multilayered polyimide film, and more particularly to a multilayered polyimide film exhibiting light shielding property or light reflectivity.

### BACKGROUND ART

Polyimides exhibit good properties, including heat resistance, dimensional stability, mechanical property, electric property, environmental resistance, and flame retardancy, and also have flexibility. Therefore, polyimides are generally used in a flexible printed board or a substrate for tape automated bonding (TAB), the printed board or the substrate being used for mounting of a semiconductor integrated circuit.

Patent Document 1 discloses a polyimide film containing, as main components, a polyimide (A) in an amount of 30 to 98 parts by mass, and an extender pigment (B) in an amount of 2 to 70 parts by mass, the polyamide (A) being formed through polycondensation between an aromatic diamine having a benzoxazole structure and an aromatic tetracarboxylic acid.

Patent Document 2 discloses a white polyimide film formed through a process in which a white pigment is mixed with a polyamic acid produced through reaction between a diamine and an aromatic tetracarboxylic acid; the resultant mixture is cast onto a support, followed by drying, to thereby form a polyimide precursor film; and the polyimide precursor film is imidized, wherein the diamine contains, as a main component, at least one species selected from among trans-diaminocyclohexane, methylenebis(cyclohexylamine), and diaminodiphenylsulfone.

### CITATION LIST

### Patent Literature

[Patent Document 1] JP-A-2007-077231
[Patent Document 2] JP-A-2008-169237

### SUMMARY OF THE INVENTION

### Technical Problem

A problem to be solved by the present invention is to provide a multilayered polyimide film having excellent heat resistance and mechanical properties, and also exhibiting light shielding property or light reflectivity.

### Solution to Problem

The present invention provides:

[1] a multilayered polyimide film comprising a polyimide layer (b), and a pigment-containing polyimide layer (a) stacked on one surface or both surfaces of the polyimide layer (b), wherein the polyimide layer (b) is formed of a polyimide including an aromatic tetracarboxylic acid unit containing a 3,3′,4,4′-biphenyltetracarboxylic acid unit in an amount of 70 to 100 mol %, and an aromatic diamine unit containing a p-phenylenediamine unit in an amount of 70 to 100 mol %;

[2] the multilayered polyimide film as described in [1] above, wherein the polyimide layer (a) is formed of a polyimide including an aromatic tetracarboxylic acid unit containing, in an amount of 70 to 100 mol %, one or more species selected from the group consisting of a pyromellitic acid unit, a 3,3′,4,4′-biphenyltetracarboxylic acid unit, and a 2,3,3′,4′-biphenyltetracarboxylic acid unit, and an aromatic diamine unit containing, in an amount of 70 to 100 mol %, one or more species selected from the group consisting of a p-phenylenediamine unit, a diaminodiphenyl ether unit, and a bis(aminophenoxy)benzene unit;

[3] the multilayered polyimide film as described in [1] or [2] above, wherein the pigment has light shielding property or light reflectivity;

[4] the multilayered polyimide film as described in [3] above, wherein the pigment is one or more pigments selected from the group consisting of carbon black, iron black, and titanium dioxide;

[5] the multilayered polyimide film as described in [4] above, wherein the pigment is nonconductive carbon black;

[6] the multilayered polyimide film as described in any of [1] to [5] above, which exhibits a light transmittance of 1% or less at a wavelength of 550 nm;

[7] the multilayered polyimide film as described in any of [1] to [6] above, wherein the ratio of the total thickness of the polyimide layer or layers (a) to the thickness of the multilayered polyimide film [(the total thickness of the polyimide layer or layers (a))/(the thickness of the multilayered polyimide film)] is 0.25 or less;

[8] a method for producing a multilayered polyimide film as described in any of [1] to [7] above, comprising:

a step of forming a polyimide layer (b) from a polyimide precursor solution (b), which solution contains a polyamic acid produced from an aromatic tetracarboxylic acid component containing 3,3′,4,4′-biphenyltetracarboxylic dianhydride in an amount of 70 to 100 mol %, and an aromatic diamine component containing p-phenylenediamine in an amount of 70 to 100 mol %; and

a step of forming a polyimide layer (a) on at least one surface of the polyimide layer (b) from a polyimide precursor solution (a) containing a polyamic acid and a pigment;

[9] the method for producing a multilayered polyimide film as described in [8] above, wherein the polyimide precursor solution (a) contains a pigment, and a polyamic acid produced from an aromatic tetracarboxylic acid component containing, in an amount of 70 to 100 mol %, a component selected from the group consisting of pyromellitic dianhydride, 3,3′,4,4′-biphenyltetracarboxylic dianhydride, and 2,3,3′,4′-biphenyltetracarboxylic dianhydride, and a diamine component containing, in an amount of 70 to 100 mol %, a component selected from the group consisting of p-phenylenediamine, a diaminodiphenyl ether compound, and a bis(aminophenoxy)benzene compound;

[10] the method for producing a multilayered polyimide film as described in [8] or [9] above, which comprises a step of casting the polyimide precursor solution (b) and the polyimide precursor solution (a) onto a support through coextrusion, followed by heating; and

[11] the method for producing a multilayered polyimide film as described in [8] or [9] above, which comprises a step of casting the polyimide precursor solution (b) onto a substrate, followed by heating, to thereby form a self-supporting film including the polyimide layer (b); and a step of applying the polyimide precursor solution (a) to the self-supporting film, followed by heating.

### Advantageous Effects of Invention

The multilayered polyimide film of the present invention has excellent heat resistance and mechanical properties, and also exhibits light shielding property or light reflectivity.

### DESCRIPTION OF EMBODIMENTS

The multilayered polyimide film of the present invention includes a polyimide layer (b), and a pigment-containing polyimide layer (a) stacked on one surface or both surfaces of the polyimide layer (b).

In the multilayered polyimide film of the present invention, the thickness of the polyimide layer (b) or the polyimide layer (a) may be appropriately determined in consideration of the intended use of the film. From the viewpoint of practical use of the film, the thickness of the polyimide layer (b) is preferably 5 to 100 μM, more preferably 5 to 80 μm, further preferably 5 to 50 μm, particularly preferably 7 to 50 μm.

The total thickness of the polyimide layer or layers (a) is preferably 0.2 to 10 μm, more preferably 0.3 to 7 μm, further preferably 0.5 to 5 μm, particularly preferably 0.7 to 4 μm, from the viewpoint of preventing impairment of the mechanical properties of the film.

The thickness of the polyimide layer (a) stacked on one surface of the polyimide layer (b) is preferably 0.1 to 5 μm, more preferably 0.2 to 3 μm, further preferably 0.25 to 2 μm, particularly preferably 0.3 to 1.5 μm, from the viewpoint of preventing impairment of the mechanical properties of the film.

The ratio of the total thickness of the polyimide layer or layers (a) to the thickness of the multilayered polyimide film (i.e., the sum of the thickness of the polyimide layer (b) and that of the polyimide layer or layers (a)) [(the total thickness of the polyimide layer or layers (a))/(the thickness of the multilayered polyimide film)] is preferably 0.25 or less, more preferably 0.20 or less, further preferably 0.18 or less, from the viewpoint of preventing impairment of the mechanical properties of the film. No particular limitation is imposed on the minimum of the ratio, so long as the effects of the present invention are not impaired. The ratio is preferably 0.001 or more, more preferably 0.01 or more.

<Polyimide Layer (b)>

The polyimide forming the polyimide layer (b) includes an aromatic tetracarboxylic acid unit containing a 3,3′,4,4′-biphenyltetracarboxylic acid unit in an amount of 70 to 100 mol %, and an aromatic diamine unit containing a p-phenylenediamine unit in an amount of 70 to 100 mol %. The polyimide exhibits excellent heat resistance. As described hereinbelow, the polyimide forming the polyimide layer (b) may be prepared from a polyimide precursor solution (b), which solution contains a polyamic acid produced from an aromatic tetracarboxylic acid component containing 3,3′,4,4′-biphenyltetracarboxylic dianhydride in an amount of 70 to 100 mol %, and an aromatic diamine component containing p-phenylenediamine in an amount of 70 to 100 mol %.

In the polyimide forming the polyimide layer (b), the aromatic tetracarboxylic acid unit contains a 3,3′,4,4′-biphenyltetracarboxylic acid unit in an amount of 70 to 100 mol %, preferably 80 to 100 mol %, more preferably 90 to 100 mol %. Examples of the aromatic tetracarboxylic acid unit other than the 3,3′,4,4′-biphenyltetracarboxylic acid unit include, but are not particularly limited to, a 2,3,3′,4′-biphenyltetracarboxylic acid unit, a pyromellitic acid unit, and a 1,4-hydroquinone dibenzoate-3,3′,4,4′-tetracarboxylic acid unit.

In the polyimide forming the polyimide layer (b), the aromatic diamine unit contains a p-phenylenediamine unit in an amount of 70 to 100 mol %, preferably 80 to 100 mol %, more preferably 90 to 100 mol %. Examples of the aromatic diamine unit other than the p-phenylenediamine unit include, but are not particularly limited to, diamine units having one or two benzene nuclei, such as an m-phenylenediamine unit, a 2,4-diaminotolidine unit, a 4,4-diaminodiphenyl ether unit, an o-tolidine unit, an m-tolidine unit, and a 4,4′-diaminobenzanilide unit (exclusive of a unit formed of two benzene nuclei and an alkylene group having two or more carbon atoms (e.g., an ethylene group), the alkylene group being provided between the benzene nuclei).

<Polyimide Layer (a)>

The polyimide forming the polyimide layer (a) preferably includes an aromatic tetracarboxylic acid unit containing, in an amount of 70 to 100 mol %, one or more species selected from the group consisting of a pyromellitic acid unit, a 3,3′,4,4′-biphenyltetracarboxylic acid unit, and a 2,3,3′,4′-biphenyltetracarboxylic acid unit, and an aromatic diamine unit containing, in an amount of 70 to 100 mol %, one or more species selected from the group consisting of a p-phenylenediamine unit, a diaminodiphenyl ether unit, and a bis(aminophenoxy)benzene unit. The polyimide exhibits excellent heat resistance.

In the polyimide forming the polyimide layer (a), the aromatic tetracarboxylic acid unit contains one or more species selected from the group consisting of a pyromellitic acid unit, a 3,3′,4,4′-biphenyltetracarboxylic acid unit, and a 2,3,3′,4′-biphenyltetracarboxylic acid unit in an amount of preferably 70 to 100 mol %, more preferably 80 to 100 mol %, further preferably 90 to 100 mol %. Examples of the aromatic tetracarboxylic acid unit other than the aforementioned ones include, but are not particularly limited to, a 1,4-hydroquinone dibenzoate-3,3′,4,4′-tetracarboxylic acid unit, a 3,3′,4,4′-benzophenonetetracarboxylic acid unit, a 3,3′,4,4′-diphenyl ether tetracarboxylic acid unit, and a 3,3′,4,4′-diphenylsulfonetetracarboxylic acid unit.

In the polyimide forming the polyimide layer (a), the aromatic diamine unit contains one or more species selected from the group consisting of a p-phenylenediamine unit, a diaminodiphenyl ether unit, and a bis(aminophenoxy)benzene unit in an amount of 70 to 100 mol %, preferably 80 to 100 mol %, more preferably 90 to 100 mol %. Examples of the aromatic diamine unit other than the aforementioned ones include, but are not particularly limited to, diamine units having one to three benzene nuclei, such as an m-phenylenediamine unit, a 2,4-diaminotolidine unit, an o-tolidine unit, an m-tolidine unit, and a 4,4′-diaminobenzanilide unit (exclusive of a unit formed of two benzene nuclei and an alkylene group having two or more carbon atoms (e.g., an ethylene group), the alkylene group being provided between the benzene nuclei).

The polyimide forming the polyimide layer (b) may be the same as or different from the polyimide forming the polyimide layer (a).

### (Pigment)

The polyimide layer (a) contains a pigment. The type and amount of the pigment may be appropriately determined in consideration of the intended use of the film. The pigment content of the polyimide layer (a) is preferably 1 to 30 parts by mass, more preferably 3 to 20 parts by mass, further preferably 3 to 15 parts by mass, on the basis of 100 parts by mass of the polyimide forming the polyimide layer (a).

The pigment contained in the polyimide layer (a) exhibits light shielding property or light reflectivity. Preferably, the pigment is nonconductive and exhibits light shielding property or light reflectivity.

Specific examples of the pigment include, but are not limited to, titanium dioxide, zinc oxide, carbon black, iron black, red iron oxide, ultramarine, cobalt blue, titanium yellow, Prussian blue, zinc sulfide, barium yellow, cobalt blue, cobalt green, quinacridone red, polyazo yellow, anthraquinone red, anthraquinone yellow, phthalocyanine blue, and phthalocyanine green. These pigments may be employed in combination of two or more species.

Preferably, the pigment is one or more pigments selected from the group consisting of carbon black, iron black, and titanium dioxide, from the viewpoint of light shielding property. More preferably, the pigment is nonconductive carbon black, from the viewpoints of nonconductivity and light shielding property.

### <Production Method for Multilayered Polyimide Film>

No particular limitation is imposed on the method for producing the multilayered polyimide film of the present invention. However, the production method preferably includes the following steps (1) and (2):

step (1): a step of forming a polyimide layer (b) from a polyimide precursor solution (b), which solution contains a polyamic acid produced from an aromatic tetracarboxylic acid component containing 3,3′,4,4′-biphenyltetracarboxylic dianhydride in an amount of 70 to 100 mol %, and an aromatic diamine component containing p-phenylenediamine in an amount of 70 to 100 mol %; and

step (2): a step of forming a polyimide layer (a) on at least one surface of the polyimide layer (b) from a polyimide precursor solution (a) containing a polyamic acid and a pigment.

In the aforementioned production method, step (1) may be followed by step (2), or step (1) may be carried out in parallel with step (2). Specifically, the multilayered polyimide film may be produced through a method in which the polyimide precursor solution (b) is cast onto a substrate, followed by heating, to thereby form a self-supporting film including the polyimide layer (b), and subsequently the polyimide precursor solution (a) is applied to the self-supporting film, followed by heating (hereinafter the method may be referred to as “first production method”). Alternatively, the multilayered polyimide film may be produced through a method in which the polyimide precursor solution (b) and the polyimide precursor solution (a) are cast onto a support through coextrusion, followed by heating (hereinafter the method may be referred to as “second production method”).

### (Raw Materials)

The polyimide layer (b) is formed from the polyimide precursor solution (b), which solution contains a polyamic acid produced from an aromatic tetracarboxylic acid component containing 3,3′,4,4′-biphenyltetracarboxylic dianhydride in an amount of 70 to 100 mol %, and an aromatic diamine component containing p-phenylenediamine in an amount of 70 to 100 mol %.

The aromatic tetracarboxylic acid component other than 3,3′,4,4′-biphenyltetracarboxylic dianhydride may be, for example, 2,3,3′,4′-biphenyltetracarboxylic dianhydride, pyromellitic dianhydride, or 1,4-hydroquinone dibenzoate-3,3′,4,4′-tetracarboxylic dianhydride.

The aromatic diamine component other than p-phenylenediamine may be, for example, a diamine having one or two benzene nuclei, such as m-phenylenediamine, 2,4-diaminotolidine, 4,4-diaminodiphenyl ether, o-tolidine, m-tolidine, or 4,4′-diaminobenzanilide (exclusive of a diamine compound formed of two benzene nuclei and an alkylene group having two or more carbon atoms (e.g., an ethylene group), the alkylene group being provided between the benzene nuclei).

The polyimide layer (a) is formed from the polyimide precursor solution (a) containing a polyamic acid and a pigment.

The pigment employed may be any of the aforementioned ones.

The polyamic acid contained in the polyimide precursor solution (a) is preferably produced from an aromatic tetracarboxylic acid component containing, in an amount of 70 to 100 mol %, one or more species selected from the group consisting of pyromellitic dianhydride, 3,3′,4,4′-biphenyltetracarboxylic dianhydride, and 2,3,3′,4′-biphenyltetracarboxylic dianhydride, and an aromatic diamine component containing, in an amount of 70 to 100 mol %, one or more species selected from the group consisting of p-phenylenediamine, a diaminodiphenyl ether compound, and a bis(aminophenoxy)benzene compound. Specific examples of the diaminodiphenyl ether compound include 3,3′-diaminodiphenyl ether, 4,4′-diaminodiphenyl ether, and 3,4′-diaminodiphenyl ether. Specific examples of the bis(aminophenoxy)benzene compound include 1,3-bis(4-aminophenoxy)benzene, 1,4-bis(4-aminophenoxy)benzene, 1,3-bis(3-aminophenoxy)benzene, and 1,4-bis(3-aminophenoxy)benzene.

Regarding the polyimide layer (a), the aromatic tetracarboxylic acid component other than the aforementioned ones may be, for example, 1,4-hydroquinone dibenzoate-3,3′,4,4′-tetracarboxylic dianhydride, 3,3′,4,4′-benzophenonetetracarboxylic dianhydride, 3,3′,4,4′-diphenyl ether tetracarboxylic dianhydride, or 3,3′,4,4′-diphenylsulfonetetracarboxylic dianhydride.

The aromatic diamine component other than the aforementioned ones may be, for example, a diamine having one to three benzene nuclei, such as m-phenylenediamine, 2,4-diaminotolidine, o-tolidine, m-tolidine, or 4,4′-diaminobenzanilide (exclusive of a diamine compound formed of two benzene nuclei and an alkylene group having two or more carbon atoms (e.g., an ethylene group), the alkylene group being provided between the benzene nuclei).

The polyimide forming the polyimide layer (b) and the polyimide forming the polyimide layer (a) may be formed from the same combination of acid and aromatic diamine components, or different combinations of acid and aromatic diamine components.

### (Preparation of Polyamic Acid)

The polyamic acid (polyimide precursor) contained in each of the polyimide precursor solutions (a) and (b) is prepared through polymerization reaction between any of the aforementioned aromatic tetracarboxylic acid components and any of the aforementioned aromatic diamine components. Each of the polyimide precursor solutions (a) and (b) preferably contains a polar organic solvent. The aforementioned polymerization reaction is preferably carried out in a polar organic solvent.

Examples of the polar organic solvent include amides such as N-methyl-2-pyrrolidone, N,N-dimethylacetamide, N,N-diethylacetamide, N,N-dimethylformamide, N,N-diethylformamide, and hexamethylsulfonamide; sulfoxides such as dimethyl sulfoxide and diethyl sulfoxide; and sulfones such as dimethyl sulfone and diethyl sulfone. These solvents may be employed singly or in combination.

The total monomer concentration of each of the polyimide precursor solutions (a) and (b) may be appropriately determined in consideration of the production method for the multilayered polyimide film. For example, when each of the polyimide precursor solutions is employed for casting, the total monomer concentration of the solution is preferably 5 to 40 mass %, more preferably 6 to 35 mass %, further preferably 10 to 30 mass %. When the polyimide precursor solution (a) is employed for application, the total monomer concentration of the solution is preferably 1 to 15 mass %, more preferably 2 to 8 mass %.

The polyamic acid (polyimide precursor) solution may be prepared by mixing any of the aforementioned aromatic tetracarboxylic acid components with any of the aforementioned diamine components in any of the aforementioned polar organic solvents so that the amounts by mole of these components are substantially the same, or the amount by mole of one of these components slightly exceeds that of the other component, and by allowing reaction of the resultant mixture to proceed at a temperature of preferably 100° C. or lower (more preferably 80° C. or lower) for about 0.2 to about 60 hours.

The viscosity of each of the polyimide precursor solutions may be appropriately determined in consideration of the intended use (e.g., application or casting) of the solution, or the intended use of the multilayered polyimide film produced. The polyamic acid (polyimide precursor) solution preferably exhibits a rotational viscosity as measured at 30° C. of about 0.1 to about 5,000 poises, more preferably about 0.5 to about 2,000 poises, further preferably about 1 to about 2,000 poises, from the viewpoint of easy handling. Therefore, the aforementioned polymerization reaction is preferably carried out to such an extent that the thus-prepared polyamic acid solution exhibits a viscosity falling within the aforementioned range.

The polyimide precursor solution (a) and/or the polyimide precursor solution (b) may contain a phosphorus-containing stabilizer (e.g., triphenyl phosphite or triphenyl phosphate) for the purpose of suppressing gelation. Such a stabilizer may be added in an amount of 0.01 to 1% with respect to the solid (polymer) content during polymerization of the polyamic acid.

The polyimide precursor solution (a) and/or the polyimide precursor solution (b) (dope) may contain a basic organic compound for the purpose of promoting imidization. For example, a basic organic compound such as imidazole, 2-imidazole, 1,2-dimethylimidazole, 2-phenylimidazole, benzimidazole, isoquinoline, or substituted pyridine may be incorporated in an amount of preferably 0.0005 to 0.1 parts by mass, more preferably 0.001 to 0.02 parts by mass, on the basis of 100 parts by mass of the polyamic acid (polyimide precursor). Such a basic organic compound may be employed for preventing insufficient imidization, which would otherwise be caused by formation of the polyimide film at a relatively low temperature.

Also, the polyimide precursor solution (raw material dope for thermal press-bonding polyimide) may contain an organic aluminum compound, an inorganic aluminum compound, or an organic tin compound for the purpose of stabilizing adhesion strength. For example, an aluminum compound such as aluminum hydroxide or aluminum tris(acetylacetonate) may be added in an amount (in terms of metallic aluminum) of preferably 1 ppm or more (more preferably 1 to 1,000 ppm) with respect to the polyamic acid.

When a self-supporting film formed of the polyimide layer (b) is produced, an organic or inorganic additive may optionally be added to the polyimide precursor solution (b).

Examples of the inorganic additive include inorganic fillers having, for example, a particulate or flat form. Specific examples include inorganic oxide powder such as fine particulate titanium dioxide powder, silicon dioxide (silica) powder, magnesium oxide powder, aluminum oxide (alumina) powder, or zinc oxide powder; inorganic nitride powder such as fine particulate silicon nitride powder or titanium nitride powder; inorganic carbide powder such as silicon carbide powder; and inorganic powder such as fine particulate calcium carbonate powder, calcium sulfate powder, or barium sulfate powder. These inorganic fine particulate powders may be employed in combination of two or more species. Such inorganic fine powder particles may be uniformly dispersed in the polyimide precursor solution (b) through any means.

Examples of the organic additive include polyimide particles and thermosetting resin particles.

The amount and shape (size and aspect ratio) of the additive employed may be determined in consideration of the intended use of the film.

### (First Production Method)

In the first production method of the present invention, firstly, the aforementioned polyimide precursor solution (b) is cast onto a substrate, followed by heating, to thereby produce a self-supporting film formed of the polyimide layer (b); subsequently, the aforementioned polyimide precursor solution (a) is applied to one surface or both surfaces of the self-supporting film, to thereby stack a layer of the polyimide precursor solution (a) on one surface or both surfaces of the self-supporting film; the thus-formed multilayered self-supporting film is heated and dried for imidization; and the resultant film is thermally treated at a maximum heating temperature of 350° C. to 600° C., preferably 450 to 590° C., more preferably 490 to 580° C., further preferably 500 to 580° C., particularly preferably 520 to 580° C. This method can produce a multilayered polyimide film which entirely exhibits satisfactory mechanical properties (including tensile elastic modulus) and thermal properties (including linear expansion coefficient).

### [Production of Self-Supporting Film]

For example, firstly, the polyimide precursor solution (b) is cast onto a surface of an appropriate support (e.g., a metallic, ceramic, or plastic roller, a metallic belt, or a roller or belt onto which a metallic thin film tape is being supplied) by means of, for example, a die, to thereby form a film having a uniform thickness of preferably about 10 to about 2,000 μm, more preferably about 20 to about 1,000 μm. Subsequently, the polar organic solvent is gradually removed through heating by means of a heat source (e.g., hot air or infrared rays) at preferably 50 to 210° C., more preferably 60 to 200° C., to thereby carry out predrying until the resultant film is imparted with self-supporting property. Thus, a self-supporting film can be produced.

When the self-supporting film is produced from the polyimide precursor solution (b), the polyimide precursor may be imidized through thermal imidization or chemical imidization.

The thus-produced self-supporting film preferably has a smooth surface (one smooth surface or both smooth surfaces) so that the polyimide precursor solution (a) can be almost uniformly (or uniformly) applied to the self-supporting film.

Preferably, the loss on heating of the self-supporting film falls within a range of 20 to 40 mass %, and the imidization rate of the self-supporting film falls within a range of 8 to 40%, from the viewpoints of, for example, the mechanical properties of the self-supporting film, application of the polyimide precursor solution (a), the adhesion strength between the polyimide layer (a) and the polyimide layer (b), and prevention of occurrence of cracking and the like.

As used herein, “loss on heating of a self-supporting film” is determined by use of the following formula:

Loss on heating (mass %)=[(W1−W2)/W1]×100

(wherein W1 represents the weight of the film as measured before drying, and W2 represents the weight of the film as measured after drying at 420° C. for 20 minutes).

As used herein, “imidization rate of a self-supporting film” can be calculated by utilizing the ratio of the peak area of the vibrational band of the film to that of a full-cured product, as measured through IR (ATR). The vibrational band may be, for example, the symmetric stretching vibrational band of an imidocarbonyl group or the stretching vibrational band of a benzene ring skeleton. The imidization rate of a self-supporting film may be determined through the technique employing a Karl Fischer moisture meter described in JP-A-9-316199.

### APPLICATION

The polyimide precursor solution (a) is applied to one surface or both surfaces of the self-supporting film formed of the polyimide layer (b), and drying is optionally carried out, to thereby produce a multilayered self-supporting film.

Application of the polyimide precursor solution (a) to the self-supporting film formed of the polyimide layer (b) may be carried out before or after removal of the self-supporting film from the support.

Preferably, the polyimide precursor solution (a), which forms the polyimide layer (a), is uniformly applied to one surface or both surfaces of the self-supporting film.

Application of the polyimide precursor solution (a), which forms the polyimide layer (a), to one surface or both surfaces of the self-supporting film may be carried out through any known application technique; for example, gravure coating, spin coating, silk screening, dip coating, spray coating, bar coating, knife coating, roll coating, blade coating, or die coating.

### (Second Production Method)

In the second production method of the present invention, the aforementioned polyimide precursor solution (b) and the aforementioned polyimide precursor solution (a) are cast onto a support through coextrusion, followed by drying, to thereby produce a multilayered self-supporting film having at least two layers, in which the polyimide layer (a) is stacked directly on one surface or both surfaces of the polyimide layer (b); the thus-produced multilayered self-supporting film is heated and dried for imidization; and the resultant film is thermally treated at a maximum heating temperature of 350° C. to 600° C., preferably 450 to 590° C., more preferably 490 to 580° C., further preferably 500 to 580° C., particularly preferably 520 to 580° C. This method can produce a multilayered polyimide film which entirely exhibits satisfactory mechanical properties (including tensile elastic modulus) and thermal properties (including linear expansion coefficient).

### [Production of Multilayered Self-Supporting Film]

For example, firstly, the polyimide precursor solution (b) and the polyimide precursor solution (a) are cast onto a surface of an appropriate support (e.g., a metallic, ceramic, or plastic roller, a metallic belt, or a roller or belt onto which a metallic thin film tape is being supplied) through coextrusion by means of, for example, a die having two or more layers, to thereby form a film having a uniform thickness of preferably about 10 to about 2,000 μm, more preferably about 20 to about 1,000 μm. Subsequently, the polar organic solvent is gradually removed through heating by means of a heat source (e.g., hot air or infrared rays) at preferably 50 to 210° C., more preferably 60 to 200° C., to thereby carry out predrying until the resultant film is imparted with self-supporting property. A multilayered self-supporting film can be produced through removal of the support therefrom.

When the multilayered self-supporting film is produced from the polyimide precursor solutions, the polyimide precursors may be imidized through thermal imidization or chemical imidization.

The loss on heating and imidization rate of the multilayered self-supporting film are determined in the same manner as described above.

When the multilayered self-supporting film is subjected to thermal imidization, the film is fixed by means of, for example, a pin tenter, a clip, or a metal. This thermal treatment is preferably carried out at a final heating temperature of 350 to 600° C. Heating temperature conditions may be appropriately determined. The thermal treatment may be carried out by means of any heating apparatus such as a hot air furnace or an infrared heating furnace. The thermal treatment may be carried out at a single heating temperature or multiple heating temperatures.

### <Properties and Application of Multilayered Polyimide Film>

The multilayered polyimide film of the present invention preferably exhibits a light transmittance (at a wavelength of 550 nm) of 1% or less, more preferably 0.5% or less, further preferably 0.1% or less, from the viewpoints of light shielding property and light reflectivity.

Preferably, the multilayered polyimide film entirely exhibits a tensile elastic modulus (MD) of 6 to 12 GPa and a linear expansion coefficient (50 to 200° C.) of 10×10⁻⁶ to 30×10⁻⁶ cm/cm/° C. This is because, when the tensile elastic modulus and the linear expansion coefficient fall within the above ranges, the film can be suitably employed as a material for electronic components, including a printed wiring board, a flexible printed board, and a TAB tape.

The multilayered polyimide film of the present invention may be employed as is. Alternatively, before use, the polyimide layer (a) and/or the polyimide layer (b) of the film may optionally be subjected to surface treatment such as chemical etching, corona discharge treatment, low-temperature plasma discharge treatment, ambient-pressure plasma discharge treatment.

The multilayered polyimide film of the present invention has excellent heat resistance and mechanical properties, and also exhibits light shielding property or light reflectivity. Therefore, the film can be employed as a material for electronic components, including a printed wiring board, a flexible printed board, and tapes for TAB, COF (chip on film) and the like.

### EXAMPLES

The present invention will next be described in more detail by way of examples, which should not be construed as limiting the invention thereto.

### (Evaluation Methods)

Light transmittance (%): transmission at a wavelength of 550 nm was measured by means of U-2800 Spectrophotometer manufactured by Hitachi High-Technologies Corporation.

Tensile strength (MPa) and elongation (%): measured according to ASTM D882.

### Referential Example 1

3,3′,4,4′-Biphenyltetracarboxylic dianhydride was polymerized with an equimolar amount of p-phenylenediamine in N,N-dimethylacetamide at 30° C. for three hours, to thereby prepare a polyamic acid solution (concentration: 18 mass %). To the polyamic acid solution were added monostearyl phosphate triethanolamine salt (0.1 parts by mass on the basis of 100 parts by mass of the polyamic acid), 1,2-dimethylimidazole (0.05 mol on the basis of 1 mol of the polyamic acid), and a silica filler (trade name: ST-ZL, product of Nissan Chemical Industries, Ltd., mean particle size: 0.08 μm) (0.5 parts by mass on the basis of 100 parts by mass of the polyamic acid), followed by uniform mixing, to thereby produce a precursor solution composition (B-1) of polyimide (b).

### Referential Example 2

3,3′,4,4′-Biphenyltetracarboxylic dianhydride was polymerized with an equimolar amount of p-phenylenediamine in N,N-dimethylacetamide at 30° C. for three hours, to thereby prepare a polyamic acid solution (concentration: 18 mass %). To the polyamic acid solution were added a silica filler (trade name: ST-ZL, product of Nissan Chemical Industries, Ltd., mean particle size: 0.08 μm) (0.5 parts by mass on the basis of 100 parts by mass of the polyamic acid), and carbon black (trade name: Mitsubishi Carbon Black, product of Mitsubishi Chemical Corporation) (5 parts by weight on the basis of 100 parts by mass of the polyamic acid), followed by uniform mixing, to thereby produce a precursor solution composition (A-1) of polyimide (a).

### Referential Example 3

3,3′,4,4′-Biphenyltetracarboxylic dianhydride was polymerized with an equimolar amount of p-phenylenediamine in N,N-dimethylacetamide at 30° C. for three hours, to thereby prepare a polyamic acid solution (concentration: 3.0 mass %). To the polyamic acid solution was added nonconductive carbon black (trade name: Mitsubishi Carbon Black, product of Mitsubishi Chemical Corporation) (5 parts by weight on the basis of 100 parts by mass of the polyamic acid), followed by uniform mixing, to thereby produce a precursor solution composition (A-2) of polyimide (a).

### Example 1

By means of a three-layer die, the precursor solution composition (B-1) and the precursor solution composition (A-2) were continuously cast onto a stainless steel substrate (support) so that the central layer of the resultant film was formed from the composition (B-1); the thickness of the film was adjusted to 10 μm after thermal drying; both surface layers of the film were formed from the composition (A-2); and the thickness of each surface layer was 2 μm after thermal drying. The thus-cast compositions were dried with hot air of 140° C., and then removed from the support, to thereby form a multilayered self-supporting film. The multilayered self-supporting film was gradually heated from 200° C. to 575° C. in a heating furnace for removal of the solvent and imidization, to thereby produce a multilayered polyimide film (X-1).

The tensile strength, elongation, and light transmittance of the multilayered polyimide film (X-1) were measured. The results are shown in Table 1.

### Example 2

By means of a single-layer die, the precursor solution composition (B-1) was continuously cast onto a stainless steel substrate (support) so that the thickness of the resultant film was 10 μm after thermal drying. The thus-cast composition was dried with hot air of 140° C., and then removed from the support, to thereby form a self-supporting film. The precursor solution composition (A-2) was applied to both surfaces of the self-supporting film so that the thickness of each surface layer was 1 μm after thermal drying. Thereafter, the resultant self-supporting film was gradually heated from 200° C. to 575° C. in a heating furnace for removal of the solvent and imidization, to thereby produce a multilayered polyimide film (X-2).

The tensile strength, elongation, and light transmittance of the multilayered polyimide film (X-2) were measured.

### Example 3

The procedure of Example 2 was repeated, except that the precursor solution composition (A-2) was applied only to the surface of the self-supporting film that had been in contact with the stainless steel substrate, to thereby produce a multilayered polyimide film (X-3) having a thickness of 9 μm.

The tensile strength, elongation, and light transmittance of the multilayered polyimide film (X-3) were measured.

### Comparative Example 1

By means of a single-layer die, the precursor solution composition (B-1) was continuously cast onto a stainless steel substrate (support) so that the thickness of the resultant film was 10 μm after thermal drying. The thus-cast composition was dried with hot air of 140° C., and then removed from the support, to thereby form a self-supporting film. The self-supporting film was gradually heated from 200° C. to 575° C. in a heating furnace for removal of the solvent and imidization, to thereby produce a single-layer polyimide film (Y-1).

The tensile strength, elongation, and light transmittance of the single-layer polyimide film (Y-1) were measured.

### Comparative Example 2

The procedure of Comparative Example 1 was repeated, except that the polyimide precursor solution (B-1) was replaced with the precursor solution composition (A-1), to thereby produce a single-layer polyimide film (Y-2).

The tensile strength, elongation, and light transmittance of the single-layer polyimide film (Y-2) were measured.

TABLE 1

| | Exam- | Exam- | Exam- | Comparative | Comparative |
|---|---|---|---|---|---|
| | ple 1 | ple 2 | ple 3 | Example 1 | Example 2 |
| Type of film | X-1 | X-2 | X-3 | Y-1 | Y-2 |
| Tensile | 410 | 440 | 450 | 460 | 280 |
| strength (MPa) | | | | | |
| Elongation (%) | 55 | 60 | 60 | 65 | 23 |
| Light | 0.1 or | 0.3 | 0.7 | 50 | 0.1 or |
| transmittance | less | | | | less |
| (%) | | | | | |

The single-layer polyimide film of Comparative Example 1, which was produced only from the precursor solution composition (B-1), exhibited unsatisfactory light transmittance, and the single-layer polyimide film of Comparative Example 2, which was produced only from the precursor solution composition (A-1), exhibited unsatisfactory tensile strength and elongation. In contrast, the multilayered polyimide films of Examples 1 to 3 exhibited excellent tensile strength and elongation, and also exhibited low light transmittance (e.g., light shielding property).

Comparison among the films of Examples 1 to 3 in terms of the ratio of the thickness of the carbon-containing polyimide layer (polyimide layer (a)) to that of the base polyimide layer (polyimide layer (b)) shows that the film of Example 1, which includes the carbon-containing polyimide layer (polyimide layer (a)) having a larger thickness, exhibits better light transmittance, whereas the film of Example 2 or 3, which includes the base polyimide layer (polyimide layer (b)) having a larger thickness, exhibits better tensile strength and elongation.

### INDUSTRIAL APPLICABILITY

The multilayered polyimide film of the present invention has excellent heat resistance and mechanical properties, and also exhibits light shielding property or light reflectivity. Therefore, the film can be suitably employed as a material for electronic components, including a printed wiring board, a flexible printed board, and tapes for TAB, COF and the like.

1. A multilayered polyimide film, comprising:
a polyimide layer (b); and
a pigment-comprising polyimide layer (a) stacked on one surface or both surfaces of the polyimide layer (b),
wherein the polyimide layer (b) comprises a polyimide comprising, in polymerized form, (i) an aromatic tetracarboxylic acid unit comprising a 3,3′,4,4′-biphenyltetracarboxylic acid unit in an amount of 70 to 100 mol %, and (ii) an aromatic diamine unit comprising a p-phenylenediamine unit in an amount of 70 to 100 mol %.

2. A multilayered polyimide film, comprising:
a polyimide layer (b); and
a pigment-comprising polyimide layer (a) stacked on one surface or both surfaces of the polyimide layer (b),
wherein the polyimide layer (a) comprises a polyimide comprising, in polymerized form,
(i) an aromatic tetracarboxylic acid unit comprising, in an amount of 70 to 100 mol %, one or more species selected from the group consisting of a pyromellitic acid unit, a 3,3′,4,4′-biphenyltetracarboxylic acid unit, and a 2,3,3′,4′-biphenyltetracarboxylic acid unit, and
(ii) an aromatic diamine unit comprising, in an amount of 70 to 100 mol %, one or more species selected from the group consisting of a p-phenylenediamine unit, a diaminodiphenyl ether unit, and a bis(aminophenoxy)benzene unit.

3. The film of claim 1, wherein the pigment has light shielding property or light reflectivity.

4. The film of claim 3, wherein the pigment is one or more pigments selected from the group consisting of carbon black, iron black, and titanium dioxide.

5. The film of claim 4, wherein the pigment is nonconductive carbon black.

6. The film of claim 1, which exhibits a light transmittance of 1% or less at a wavelength of 550 nm.

7. The film of claim 1, wherein a ratio of a total thickness of the polyimide layer or layers (a) to a thickness of the multilayered polyimide film:
[(the total thickness of the polyimide layer or layers (a))/(the thickness of the multilayered polyimide film)],
is 0.25 or less.

8. A method for producing the film of claim 1, the method comprising:
forming the polyimide layer (b) from a polyimide precursor solution (b), which solution comprises a polyamic acid produced from an aromatic tetracarboxylic acid component comprising 3,3′,4,4′-biphenyltetracarboxylic dianhydride in an amount of 70 to 100 mol %, and an aromatic diamine component comprising p-phenylenediamine in an amount of 70 to 100 mol %; and
forming a polyimide layer (a) on at least one surface of the polyimide layer (b) from a polyimide precursor solution (a) comprising a polyamic acid and a pigment.

9. A method for producing the film of claim 2, the method comprising:
forming the polyimide layer (b) from a polyimide precursor solution (b), which solution comprises a polyamic acid produced from an aromatic tetracarboxylic acid component comprising 3,3′,4,4′-biphenyltetracarboxylic dianhydride in an amount of 70 to 100 mol %, and an aromatic diamine component comprising p-phenylenediamine in an amount of 70 to 100 mol %; and
forming a polyimide layer (a) on at least one surface of the polyimide layer (b) from a polyimide precursor solution (a) comprising a pigment, and a polyamic acid produced from (i) an aromatic tetracarboxylic acid component comprising, in an amount of 70 to 100 mol %, at least one component selected from the group consisting of pyromellitic dianhydride, 3,3′,4,4′-biphenyltetracarboxylic dianhydride, and 2,3,3′,4′-biphenyltetracarboxylic dianhydride, and (ii) a diamine component comprising, in an amount of 70 to 100 mol %, at least one component selected from the group consisting of p-phenylenediamine, a diaminodiphenyl ether compound, and a bis(aminophenoxy)benzene compound.

10. The method of claim 8, further comprising:
casting the polyimide precursor solution (b) and the polyimide precursor solution (a) onto a support through coextrusion, followed by heating.

11. The method of claim 8, further comprising:
casting the polyimide precursor solution (b) onto a substrate, followed by heating, to thereby form a self-supporting film including the polyimide layer (b); and
applying the polyimide precursor solution (a) to the self-supporting film, followed by heating.

12. The film of claim 2, wherein the pigment has light shielding property or light reflectivity.

13. The film of claim 12, wherein the pigment is one or more pigments selected from the group consisting of carbon black, iron black, and titanium dioxide.

14. The film of claim 13, wherein the pigment is nonconductive carbon black.

15. The film of claim 2, which exhibits a light transmittance of 1% or less at a wavelength of 550 nm.

16. The film of claim 2, wherein a ratio of a total thickness of the polyimide layer or layers (a) to a thickness of the multilayered polyimide film:
[(the total thickness of the polyimide layer or layers (a))/(the thickness of the multilayered polyimide film)],
is 0.25 or less.

17. The method of claim 9, further comprising:
casting the polyimide precursor solution (b) and the polyimide precursor solution (a) onto a support through coextrusion, followed by heating.

18. The method of claim 9, further comprising:
casting the polyimide precursor solution (b) onto a substrate, followed by heating, to thereby form a self-supporting film including the polyimide layer (b); and
applying the polyimide precursor solution (a) to the self-supporting film, followed by heating.

19. The film of claim 3, which exhibits a light transmittance of 1% or less at a wavelength of 550 nm.

20. The film of claim 4, which exhibits a light transmittance of 1% or less at a wavelength of 550 nm.
